(19) United States
(12) Patent Application Publication
(10) Pub. No.: US 2014/0193555 A1
(43) Pub. Date: Jul. 10, 2014

(54) Treatment of human milk

(71) Applicant: MEDELA HOLDING AG, Baar (CH)

(72) Inventors: Charles Czank, Leeming (AU); Danielle K. Prime, Gnangara (AU); Peter E. Hartmann, Gooseberry Hill (AU); Anthony D. Keil, Karrinyup (AU); Naomi Jean Trengove, Trigg (AU)

(73) Assignee: Medela Holding AG

(21) Appl. No.: 13/999,129

(22) Filed: Sep. 19, 2008

Related U.S. Application Data
(63) Continuation-in-part of application No. 11/903,360, filed on Sep. 21, 2007, now abandoned.
Application No. 11/903,360 is a continuation-in-part of application No. PCT/CH2007/000155, filed on Mar. 21, 2007.
Application No. PCT/CH2007/000155 is a continuation-in-part of application No. PCT/AU2007/001412, filed on Sep. 24, 2007.
(60) Provisional application No. 60/846,544, filed on Sep. 22, 2006.
(60) Provisional application No. 60/787,727, filed on Mar. 30, 2006.
(60) Provisional application No. 60/846,544, filed on Sep. 22, 2006.

(51) Int. Cl. A23C 3/03

(52) U.S. Cl. CPC A23C 3/03
USPC 426/417; 426/522

(57) ABSTRACT

The invention provides a method for pasteurizing mother's milk that maximizes the retention of immunologically active constituents of the milk while removing effective amounts of dangerous bacteria and viruses. This includes a pasteurization temperature in the range of 56° C. to 61° C. at which the milk is held during pasteurization for a time span. The invention also provides a method for adjusting the fat content of mother's milk. This includes a method to standardize the energy content of mother's milk by adjusting the fat content by separating the milk contents, as by centrifuging, into at least fat and skim milk layers. The volume of skim milk is adjusted to meet the desired fat concentration, i.e., skim is removed to increase, or added to decrease.

### APPLICATION HISTORY

Applicant claims the benefit of International Application No. PCT/CH2007/000155, filed on Mar. 21, 2007 and claiming priority to U.S. Provisional Application Ser. No. 60/787,727, of International Application No. PCT/AU2007/001412, filed Sep. 24, 2007 and of U.S. patent application Ser. No. 11/903,360, filed on Sep. 21, 2007, both claiming priority to U.S. Provisional Application Ser. No. 60/846,544, and of US Provisional Application No. 61/024,094, filed on Jan. 28, 2008.

### TECHNICAL FIELD

The invention relates to the field of heat treatment of human milk, and particularly to the pasteurization of human milk, as well as the adjustment of the fat content of expressed human milk.

### BACKGROUND OF THE INVENTION

When mother's breastmilk is expressed, as by the use of a breastpump, it is most typically collected for later use. This ordinarily requires some kind of storage of the milk. That can include a simple step of freezing the milk, as in a home environment. In a hospital or other clinical-type environment, simple freezing may not suffice, or be desirable. Further, if the storage is going to be fairly long-term, or if the milk is being donated for others to use, as in a so-called milk bank, then a pasteurization step or heat treatment is often required.

Heat treatment of milk is well known in the field of treatment of cow's milk but equally in the field of treatment of human milk. The aim of the heat treatment is generally to remove microbial and/or viral contamination of the milk as well as promote longer storage times. Clearly a highly efficient and lasting removal of these contaminations is desired while keeping the valuable constituents of the milk in a substantially unaltered state.

For a general overview of heat treatment of human milk, reference is made to the introductory portion of International Publication No. WO 00/74494. Specific attention is drawn to the so-called Holder-pasteurization for the removal of microbial contamination, which in an exemplary embodiment is described to involve a heat treatment during 30 minutes at a holding temperature of 62.5° C. The specific disclosure of WO 00/74494 and the actual invention described therein pertains to a very short time heat treatment, namely a treatment of human milk at a temperature of at least 65° C. during a time span of at most 20 seconds, possibly combined with rotational motion during the heat treatment. This heat treatment should lead to a deactivation of specific microorganisms, namely Cytomegalovirus (CMV) as well as Staphylococcus, while at the same time keeping the immunological properties of the milk unchanged.

US Patent Publication No. 2002/0031462 describes heat treatment of milk for the removal of the HIV virus for bottle feeding term babies. It proposes to apply a heat treatment step at 62° C. during a time period of 30 minutes in ready to use feed volumes.

Most pasteurizing processes used to the foregoing end in milk banks, however, tend to have a heating time and temperature that is likely to damage proteins and other constituents of the milk. This is, perhaps, a function of how cow's milk is treated, since maintaining protein bioactivity is not a concern with the latter.

A different storage issue is related to the fat content of the milk. In actuality, this has broader implications than just storage, as will be noted below. The “energy” content of human milk can be related to the fat content of the milk. If the fat content is too low in mother's milk donated to a milk bank, then it may be of little use for feeding. In a related vein, increasing the fat content of a particular mother's own milk can be of great value when dealing with a premature or underweight infant, or an infant that is having trouble feeding.

### SUMMARY OF THE INVENTION

One aspect of the present invention is to provide an improved method for heat treatment of human milk, in particular for a broadband and lasting removal of bacterial and/or viral contamination, while keeping the most important immunologically active constituents of the milk substantially unchanged. Specifically, a method for heat treatment of human milk was found complying with the above requirements, wherein the milk is kept at an elevated temperature in the narrow range of 57-61° C. during a time span in the range of 5-60 minutes, with the proviso that for temperatures above 60° C. (but still below 61° C.) the milk is kept at this elevated temperature for less than 30 minutes. It was found that only in this very specific window an efficient process is possible. If the temperature is kept below the given temperature range or if the heat treatment is applied for a time shorter than the time span given, there is insufficient broadband microbial and viral protection. If on the other hand, a temperature above the given range is applied or the heat treatment is applied for a longer time span, the immunologically important constituents such as lactoferrin, lysozyme, IgA, sIgA (representing ˜38% of the total protein content of human milk), IgM, IgG, lipoprotein lipase, bile salt activated lipase, Vitamin A, Vitamin B12, oligosaccharides, free fatty acids, monoglycerides, folic acid, and of those, in particular, lactoferrin, sIgA, and lysozyme, start to degrade and to lose efficiency very quickly. Only in this very narrow window of conditions both requirements (broadband removal of microbial and/or viral contamination and not altering the immunologically active constituents) can indeed be fulfilled.

To achieve better results, the human milk may be kept at a temperature in the range of 59-61° C. If instrumentation allows, even better microbial and/or viral protection can be achieved while keeping the immunological constituents in an unaltered state if the human milk is kept at a temperature in the range of 59-60° C.

In one embodiment of the present invention, the elevated temperature is applied during a time span of at least 15 minutes and not more than or less than 30 minutes.

In another embodiment of the present invention, the elevated temperature is held constant during the entire time span.

In yet another embodiment, the temperature is cycled or tailored to a specific temperature profile. For example, it is possible to apply the elevated temperature in intervals (e.g., of up to several minutes) of elevated temperature and intermediate intervals (e.g., of up to several minutes) of a temperature at least 20° C. below the value of the elevated temperature (preferably well below room temperature, e.g., at below 10° C. or at below 4-6° C.). The time span is then given by the accumulated time of the intervals of elevated temperature. The heating and cooling times may be chosen quite short as microbial viability is greatly affected by rapid changes in temperature.

According to a further embodiment, the time that it takes the milk to rise from approximately room temperature to the elevated temperature may range from 10-120 seconds. Further, the time it takes for the milk to go from the elevated temperature to approximately room temperature (preferably well below room temperature, e.g. below 10° C. or below 4-6° C.) may range from 10-120 seconds.

Another embodiment of the present invention relates to the use of a method as given above for the production of microbiologically and/or virally safe breastmilk while keeping the level of at least one of the following constituents at a value substantially equal to the value of untreated human milk: lactoferrin, lysozyme, IgA, sIgA, IgM, IgG, lipoprotein lipase, bile salt activated lipase, Vitamin A, Vitamin B12, oligosaccharides, free fatty acids, monoglycerides, and folic acid.

A further embodiment of the present invention is a method for pasteurization of mother's milk that maximizes the retention of protein bioactivity while still removing effective amounts of deleterious bacteria. This method includes an optimal temperature in the range of about 56° C. to a maximum temperature of less than about 60° C. at which the milk is held during pasteurization, as well as a very rapid rise to and then fall off from that holding temperature. The temperature of the milk rises more slowly as it approaches the pasteurization temperature. Preferably a preheat temperature of >2° C. above the pasteurization temperature is contemplated, so that the milk reaches pasteurization temperature rapidly and then is held at the temperature.

Another aspect of the invention is an improved method for adjusting the fat content of mother's milk. More particularly, this can be a method to standardize the energy content of mother's milk by adjusting the fat content. The improved method comprises separating the milk contents, as by centrifuging, into at least fat and skim milk layers. This is accomplished in a manner so that the fat layer is dense enough to have a majority of the milkfat in this layer, yet not so dense as to prevent simple resuspension thereafter, as by gentle shaking or stirring. The volume of skim milk is then adjusted to meet the desired fat concentration, i.e., skim is removed to increase, or added to decrease.

These and other aspects, advantages, features and benefits of the invention will become apparent from the following specification.

### BRIEF DESCRIPTION OF THE FIGURES

FIG. 1 shows a prior art pasteurization curve (time vs. temperature);

FIG. 2 is a schematic view of the individual steps of pasteurizing human milk, wherein a) shows the step of thawing; b) shows the step of dosing; c) shows the step of heat treatment; and d) shows the step of bottling of the milk;

FIG. 3 is a view of a possible apparatus for the treatment of human milk;

FIG. 4 shows the results of the bacterial culture after pasteurization in accordance to the present invention;

FIG. 5 shows the results of the sIgA levels after pasteurization in accordance to the present invention;

FIG. 6 a) shows the results of the lactoferrin levels after pasteurization in accordance to the present invention; and b) shows the details of the lactoferrin levels around the critical temperature used in the present invention.

FIG. 7 shows a pasteurization curve (time vs. temperature) according to an embodiment of the present invention; and

FIG. 8 shows standardization of fat concentration of breast milk according to an embodiment of the present invention.

### DETAILED DESCRIPTION OF THE PREFERRED EMBODIMENTS

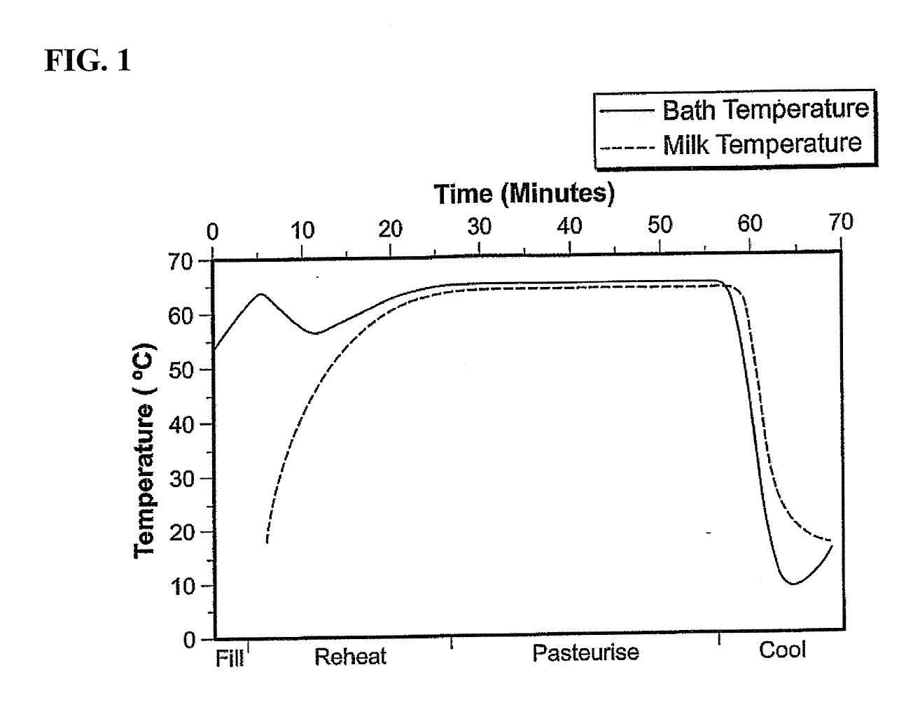

FIG. 1 shows a typical prior art technique for pasteurizing mother's milk (Sterifeed model). As will be noted, this technique uses a heating bath that relatively slowly brings the milk temperature up to a level over 60° C. (about 63° C.), where it is held for about 30 minutes. Then, a relatively slow cooldown occurs.

The present invention provides an improved method for heat treatment of human milk, in particular for a broadband and lasting removal of bacterial and/or viral contamination, while keeping the most important immunologically active constituents of the milk substantially unchanged. Surprisingly, it has been found in extensive research that only in a very narrow temperature range and only if such temperature is applied during a specific time span, can a broad range of bacterial and/or viral contamination be removed from human milk while keeping the most important immunological constituents in unaltered state. The slightest deviation from either the narrow temperature range or the applied time span either leads to an insufficient protection from bacterial and/or viral contamination or irreversibly destroys or renders inactive the most important immunological constituents of human milk.

Specifically, a method for heat treatment of human milk was found meeting the above requirements, wherein the milk is kept at an elevated temperature in the narrow range of 57-61° C. during a time span in the range of 5-60 minutes, with the proviso that for temperatures above 60° C. (but still below 61° C.) the milk is kept at this elevated temperature for less than 30 minutes. It was found that only in this very specific window is an efficient process possible. If the temperature is kept below the given temperature range or if the heat treatment is applied for a time shorter than the time span given, there is insufficient broadband microbial and viral protection. If on the other hand a temperature above the given range is applied or the heat treatment is applied for a longer time span, the immunologically important constituents such as lactoferrin, lysozyme, IgA, sIgA (representing ˜38% of the total protein content of human milk), IgM, IgG, lipoprotein lipase, bile salt activated lipase, Vitamin A, Vitamin B12, oligosaccharides, free fatty acids, monoglycerides, folic acid, and of those, in particular, lactoferrin, sIgA, and lysozyme, start to degrade and to lose efficiency very quickly. Only in this very narrow window of conditions both requirements (broadband removal of microbial and/or viral contamination and not altering the immunologically active constituents) can indeed be fulfilled.

Even higher specificity can be achieved if the human milk is kept at a temperature in the range of 59-61° C. If instrumentation allows, even better microbial and/or viral protection can be achieved while keeping the immunological constituents in an unaltered state when the human milk is kept at a temperature in the range of 59-60° C.

According to one embodiment, the elevated temperature is applied during a time span of at least 15 minutes and not more than or less than 30 minutes.

The pasteurization method may involve a single step heat treatment in which the elevated temperature is held constant during the entire time span. Alternately, the pasteurization method may involve cycling or specifically tailoring a temperature profile. For example, the elevated temperature may be applied in intervals (e.g., of up to several minutes) of elevated temperature and intermediate intervals (e.g., of up to several minutes) of a temperature at least 20° C. below the value of the elevated temperature (preferably well below room temperature, e.g. at below 10° C. or at below 4-6° C.). The time span is then given by the accumulated time of the intervals of elevated temperature. The heating and cooling times may be chosen to be quite short as microbial viability is greatly affected by rapid changes in temperature.

According to a further embodiment, the time it takes the temperature of the milk to rise from approximately room temperature to the elevated temperature may range from 10-120 seconds. Further, the time it takes the temperature of the milk to decay from the elevated temperature to approximately room temperature (preferably well below room temperature, e.g. below 10° C. or below 4-6° C.) may range from 10-120 seconds.

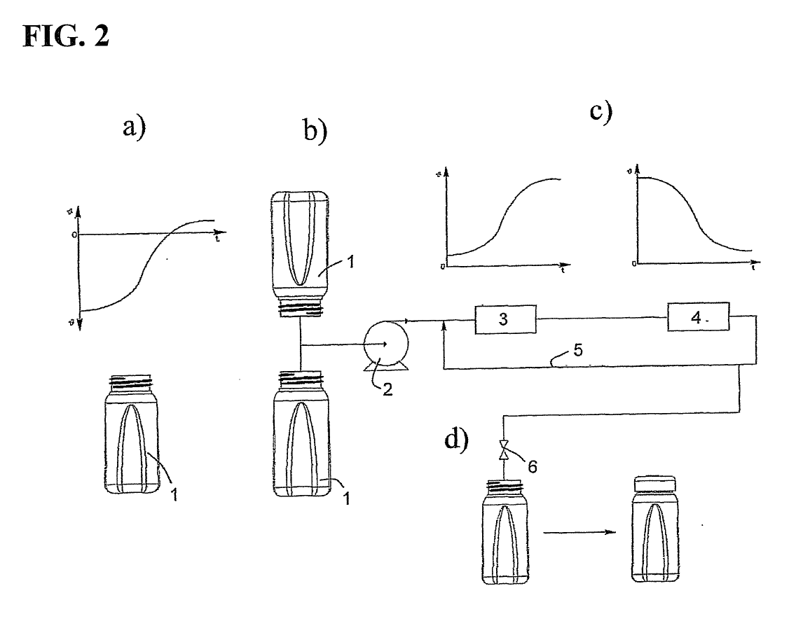

Referring to the drawings, which are for the purpose of illustrating the present embodiments of the invention and not for the purpose of limiting the same, FIG. 2 shows in a schematic display the individual steps of the heat treatment of human milk. Since human milk is usually stored in frozen state, the first step is usually to defrost the milk (internal or external), which is kept in a milk bottle 1, as indicated in FIG. 2a. For this step, a time in the range of 5-60 minutes is allowed for reaching approximately room temperature.

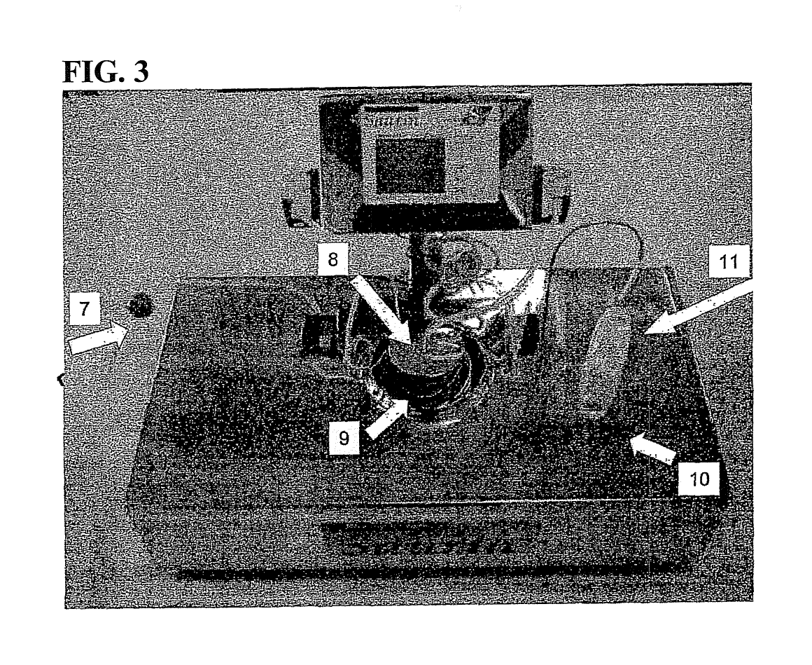

In the next step (FIG. 2b), the milk is dosed from the milk bottle(s) 1 by means of a milk pump 2 into a holding chamber 8 (shown in FIG. 3). In this holding chamber 8, the actual heat treatment takes place, involving at least one heating step 3 and at least one cooling step 4.

As indicated schematically, a sequence of intervals with heating steps and cooling steps is possible by repeating (at reference 5). To ensure that all milk has the same conditioning, single portions and bigger quantities should be treated. After the heat treatment in a temperature window as given above and within a time span as detailed above, the milk is ready to be bottled (at 6) as is schematically indicated in FIG. 2d. In this last step, the milk bottle 1 is also sealed and labelled with details such time and date, and batch number.

FIG. 3 shows a device that can be used for the heat treatment of FIG. 2. On the left-hand side, the input means 7 for the donated breast milk is positioned, which allows the transfer of human milk to the holding chamber 8. This area is provided with a heating coil 9 to allow for smoothly heating the human milk in the holding chamber 8. The display and control means at the top of the figure allow the temperature to be adjusted and monitored. A temperature sensor is located in the holding chamber to control the temperature so that it remains in the claimed range. Subsequently the heat treated human milk is guided by a tubing to a chilling compartment 10, and thereafter the pasteurized breast milk 11 can be bottled and labelled as schematically indicated in FIG. 2d.

In order to evaluate the specificity of the temperature range and the time span used, extensive experiments were carried out. Initially, four temperatures were measured, namely 40, 57, 63 and 72° C., and then detailed measurements of bacterial contaminations around the critical temperature range were taken. Five or six samples were measured and subjected to heat treatment at the temperatures, and for analysis probes were taken at various time intervals, namely at 0, 15, 30 and 45 minutes as well as one probe without any treatment (labelled “Pre”) and one probe after the heat treatment, that is shortly after the milk samples have been chilled to ˜6° C. (labelled “Post”).

The bacterial efficacy of this treatment was assessed by means of a standard culture test in order to check whether a sufficient bacterial protection was provided by the heat treatment. Each milk sample was cultured onto 5% horse blood agar plates and incubated for 48 hours at 35° C. After incubation, any microbial growth was identified to species level using standard microbiological methods.

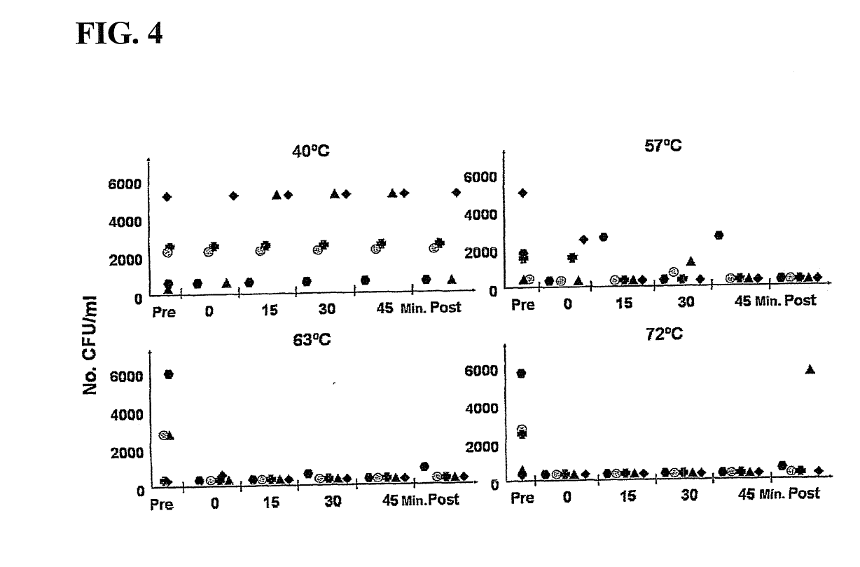

The results of these measurements are summarized in FIG. 4. The removal of bacterial contaminations very specifically starts at 57° C. Further detailed investigations revealed that an even more pronounced broadband efficiency of the bacterial removal as to be found in the appended claims, namely at a minimum temperature of 59° C. is possible if the heat treatment is applied within an (accumulated) time span of 5-60 minutes. Care should be taken if the temperature rises above 60° C. in which case a time interval of less than 30 minutes should be chosen.

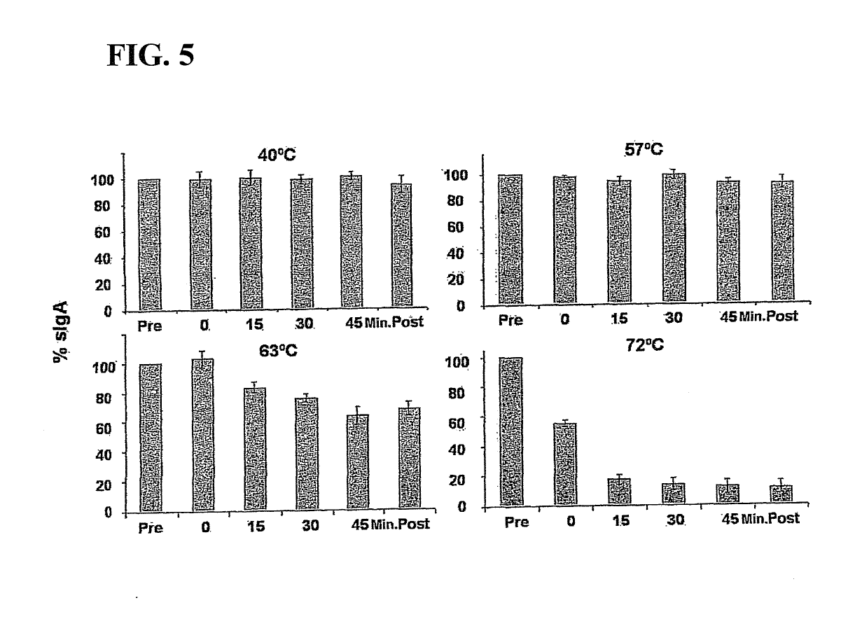

FIG. 5 shows the results of the sIgA-levels after the pasteurization. Indeed, at temperatures above 61° C., the sIgA levels of starts to drop significantly.

The results of the measurement of lactoferrin are given in table 1 below.

TABLE 1

| | Time point | | | | | | | | | | % |
|---|---|---|---|---|---|---|---|---|---|---|---|
| | (min) | 1 | 2 | 3 | 4 | 5 | 6 | Avg | SD | SEM | change |
| 40 | Pre | 0.74 | 0.87 | 0.91 | 0.81 | 1.04 | | 0.87 | 0.11 | 0.05 | 100.00 |
| (n = 5) | 0 | 1.02 | 0.79 | 0.85 | 0.95 | 1.16 | | 0.96 | 0.14 | 0.06 | 109.83 |
| | 15 | 0.85 | 0.85 | 0.87 | 0.94 | 0.97 | | 0.89 | 0.05 | 0.02 | 102.67 |
| | 30 | 0.88 | 0.83 | 0.92 | 0.90 | 0.94 | | 0.89 | 0.04 | 0.02 | 102.37 |
| | 45 | 0.75 | 0.76 | 0.82 | 1.11 | 0.80 | | 0.85 | 0.15 | 0.07 | 97.33 |
| | Post | 0.65 | 0.68 | 0.88 | 1.01 | 0.84 | | 0.81 | 0.15 | 0.07 | 93.07 |
| | RT | | | | 1.03 | 0.68 | | 0.86 | 0.25 | 0.18 | 98.17 |
| 57 | Pre | 0.70 | 0.92 | 1.09 | 0.61 | 0.94 | | 0.85 | 0.19 | 0.09 | 100.00 |
| (n = 5) | 0 | 0.80 | 0.56 | 1.07 | 0.79 | 0.94 | | 0.83 | 0.19 | 0.08 | 97.79 |
| | 15 | 0.84 | 0.52 | 1.08 | 0.81 | 0.93 | | 0.84 | 0.21 | 0.09 | 97.86 |
| | 30 | 0.87 | 0.56 | 0.94 | 0.79 | 0.99 | | 0.83 | 0.17 | 0.08 | 97.16 |
| | 45 | 0.76 | 0.43 | 0.98 | 0.94 | 0.89 | | 0.80 | 0.22 | 0.10 | 93.89 |
| | Post | 0.76 | 0.47 | 0.94 | 0.66 | 0.74 | | 0.72 | 0.17 | 0.08 | 83.84 |
| | RT | | 0.96 | 1.06 | 0.66 | 0.75 | | 0.86 | 0.19 | 0.09 | 100.55 |
| 63 | Pre | 0.83 | 0.60 | 0.78 | 0.85 | 0.82 | 0.82 | 0.78 | 0.09 | 0.04 | 100.00 |
| (n = 6) | 0 | 0.27 | 0.57 | 0.47 | 0.46 | 0.95 | 0.93 | 0.61 | 0.27 | 0.11 | 77.33 |
| | 15 | 0.23 | 0.17 | 0.07 | 0.08 | 0.15 | 0.22 | 0.15 | 0.07 | 0.03 | 19.35 |
| | 30 | 0.15 | 0.04 | 0.06 | 0.05 | 0.18 | 0.15 | 0.10 | 0.06 | 0.03 | 13.21 |
| | 45 | 0.16 | 0.09 | 0.06 | −0.01 | 0.13 | 0.23 | 0.11 | 0.08 | 0.03 | 14.10 |
| | Post | | −0.16 | 0.12 | −0.03 | 0.09 | 0.15 | 0.03 | 0.13 | 0.06 | 4.41 |
| | RT | | | 0.84 | 0.78 | 0.82 | 0.98 | 0.85 | 0.09 | 0.04 | 108.96 |
| 72 | Pre | 0.91 | 0.91 | 1.01 | 1.20 | 1.08 | 0.83 | 0.99 | 0.14 | 0.06 | 100.00 |
| (n = 6) | 0 | −0.01 | −0.07 | 0.01 | 0.21 | 0.08 | −0.04 | 0.03 | 0.10 | 0.04 | 3.12 |
| | 15 | −0.06 | −0.10 | 0.01 | 0.02 | 0.05 | −0.03 | −0.02 | 0.05 | 0.02 | −1.89 |
| | 30 | −0.10 | −0.09 | −0.03 | 0.08 | 0.01 | −0.03 | −0.03 | 0.07 | 0.03 | −2.74 |
| | 45 | −0.08 | −0.10 | −0.05 | 0.07 | 0.03 | −0.04 | −0.03 | 0.07 | 0.03 | −2.72 |
| | Post | −0.09 | −0.09 | −0.05 | 0.04 | −0.04 | −0.05 | −0.05 | 0.05 | 0.02 | −4.54 |
| | RT | | | 1.03 | 0.96 | 0.59 | 0.84 | 0.86 | 0.20 | 0.10 | 86.37 |
| 62 | Pre | 0.93 | 1.00 | 0.91 | 1.13 | 0.85 | | 0.96 | 0.11 | 0.05 | 100.00 |
| (n = 5) | 0 | 1.05 | 1.09 | 0.93 | 1.11 | 0.92 | | 1.02 | 0.09 | 0.04 | 105.94 |
| | 15 | 0.83 | 0.73 | 0.55 | 0.72 | 0.56 | | 0.68 | 0.12 | 0.05 | 70.28 |
| | 30 | 0.68 | 0.50 | 0.41 | 0.51 | 0.44 | | 0.51 | 0.11 | 0.05 | 52.68 |
| 60 | Pre | 0.83 | 0.77 | 0.71 | 0.93 | 0.91 | | 0.83 | 0.09 | 0.04 | 100.00 |
| (n = 5) | 0 | 0.84 | 0.81 | 0.79 | 1.00 | 0.86 | | 0.86 | 0.08 | 0.04 | 103.56 |
| | 15 | 0.81 | 0.66 | 0.62 | 0.89 | 0.81 | | 0.76 | 0.12 | 0.05 | 91.21 |
| | 30 | 0.85 | 0.61 | 0.55 | 0.93 | 0.94 | | 0.78 | 0.19 | 0.08 | 93.31 |

The measurements designated with RT each refer to a sample that was taken from the initial donor milk and left to sit at room temperature for the duration of the pasteurization process in order to act as a control that it was in fact the heat impacting the proteins, not time. The measurements designated with Post each refer to a sample taken from the milk once it had exited the machine and cooled to 4° C. within a few minutes of exiting the system.

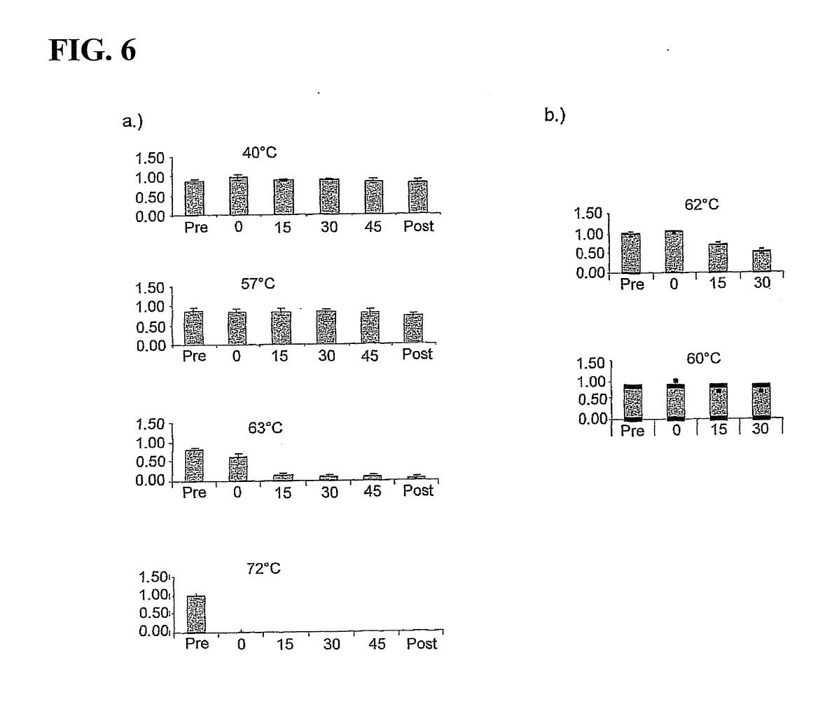

The results are graphically illustrated in FIG. 6 a) and b). One can clearly see that at a temperature of 62° C. already a significant part of the lactoferrin is degraded, while at 60° C. hardly any effect is noted on the lactoferrin level. Thus, the results show that at 62° C. most of the lactoferrin is lost whereas at e.g. 60° C. so up to 61° C. the protein is retained. The detection of lactoferrin was by using a specific polyclonal antibody to lactoferrin so that at 62° C. the protein was altered to the extent that the antibodies did not recognize it (bind to it). Therefore, one can safely assume that it has also lost its function as most functions depend on the specific structure of a protein. Similar results were obtained for lysozyme in that its activity was retained at 60° C. so up to 61° C. but lost at 62° C.

The present invention also relates to the use of the method discussed above for the production of microbiologically and/or virally safe breast milk while keeping the level of at least one of the following constituents at a value substantially equal to the value of untreated human milk: lactoferrin, lysozyme, IgA, sIgA, IgM, IgG, lipoprotein lipase, bile salt activated lipase, Vitamin A, Vitamin B12, oligosaccharides, free fatty acids, monoglycerides, folic acid, and of those in particular lactoferrin, sIgA, and lysozyme.

The milk treated according to the present invention can be used for the feeding of babies, in particular preterm babies.

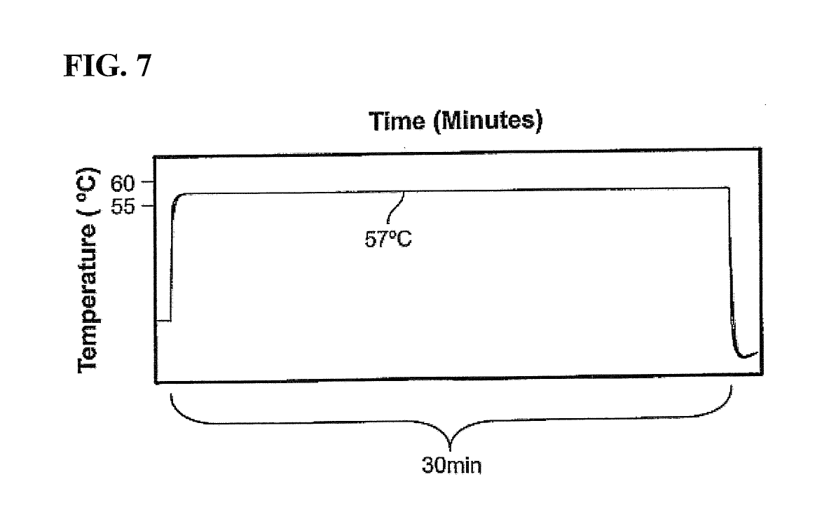

In another embodiment of the present invention, the method includes the steps of bringing the milk to a pasteurization temperature more rapidly, such as in about one (or even less than one) to five minutes, and lowering the temperature at which pasteurization is to be effected to at or below about 60° C., and most preferably about 57° C. This method of pasteurization is depicted in FIG. 7.

Applicant has determined that there is about a 60% retention of sIgA (Secretory immunoglobulin A) at an “accepted” milk banking temperature of 62.5° C. for 30 minutes. Yet at 57° C. for the same 30 minutes there is almost total retention. Further, deleterious bacteria will tend to be affected by rapid changes in temperature, more than individual proteins. Beneficial results have been determined from about 56° C. to less than about 60° C. This embodiment of the present invention therefore increases the temperature rapidly up to an optimal temperature of about 57° C., and holds that temperature for a sufficient time, here indicated at 30 minutes. The cool down period is preferably about five minutes.

A further embodiment of the present invention was developed as follows. A custom built human milk banking pasteurizer (offered by Saurin Industries, Australia) and an experimental pasteurizer (offered by Curag AG, Switzerland) were compared. Secretory immunoglobulin A (sIgA), lysozyme and lactoferrin were quantified using an Enzyme Linked Immunosorbent Assay (ELISA) and the presence of bacteria before and after pasteurization determined using microbiological techniques. Nearly 100% retention of all three proteins was achieved when pasteurizing human milk at 57° C. for up to 45 minutes in both pasteurizers. Comparatively, at 62.5° C. for 30 minutes, the retention of sIgA, lysozyme and lactoferrin was 62%, 36%, and 13% respectively. In addition, 99% of bacteria initially present in human milk were also removed at the lower pasteurizing temperature. Thus, a slightly lower pasteurization temperature (57° C. for up to 45 minutes) is as effective at sterilizing milk as the currently accepted temperature (62.5° C. for 30 minutes) but retains a greater percentage of beneficial proteins.

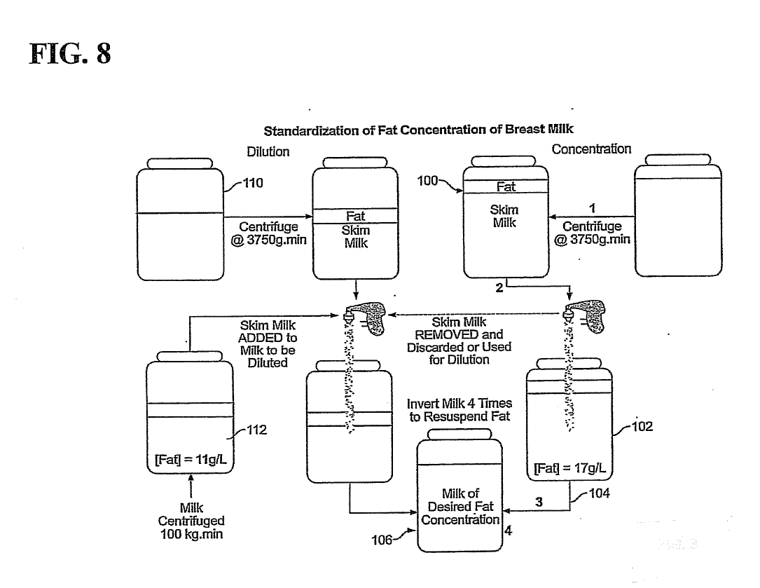

In a related development, a method for adjusting the fat concentration of mother's milk is shown in FIG. 8. These are the steps as shown in this embodiment:
1) The milk is centrifuged at 3750 g.min at 4° C. to form a fat layer 100. The fat layer is dense enough so that the majority of the fat goes into the layer, but loose enough that it can be resuspended later. It is noted that the centrifugation conditions determine how dense the fat layer is, and therefore how easy it is to resuspend the fat layer back into the milk. Under these indicated conditions, all the fat will resuspend easily. If the milk is centrifuged under any significantly higher conditions, the fat layer will be too dense, and any significantly less, the layer is too weak to remove the skim milk through. Of course, there is some latitude in the foregoing, and the indicated parameters of temperature and force are not absolutes. If the process requires concentration the method begins at 100. If the process requires dilution, the process begins at 110. After being centrifuged, skim milk is added at 112. The process proceeds as described above at 104 and 106.
2) The volume of the skim milk below the fat layer is adjusted 102 to meet the desired fat concentration.
3) The fat layer is resuspended 104 by simply inverting the container, for example four times. This is optimal to prevent frothing and therefore protein denaturation.
4) Reconstituted milk 106 is of a desired fat concentration and therefore energy content.

The following algorithm was used to determine the volume of skim milk to remove at step 2:

$$\begin{matrix}The volume of the skim milk below the fat layer is adjusted 102 to meet the desired fat concentration . & 2 ) \\ The fat layer is resuspended 104 by simply inverting the container , for example four times . This is optimal to prevent frothing and therefore protein denaturation . & 3 ) \\ Reconstituted milk 106 is of a desired fat concentration and there for energy content . & 4 )\end{matrix}$$

This equation is in its simplest form, and takes into account the fat content of the milk initially, the fat content of the skim after centrifugation and the desired fat content.

There is a more advanced algorithm that takes into account the initial concentrations of lactose and protein in addition to the above variables. This is based on the WHO recommendations for energy from fat=9 Kcal/g, protein=4 Kcal/g and carbohydrates=4 Kcal/g.

$$Simple fat standardization algorithm \text{:}$$

$${V}_{2} = \frac{{V}_{1} {C}_{1} - {V}_{1} {C}_{3}}{{C}_{3} - {C}_{2}}$$

$$Where \text{:}$$

$${V}_{1} = Initial volume of milk ( ml )$$

$${V}_{2} = Volume of skim milk to be removed or added ( ml )$$

$${V}_{3} = Final volume of milk after adjustment ( ml )$$

$${C}_{1} = Initial concentration of fat ( g / L )$$

$${C}_{2} = Concentration off at in skim milk to be added or removed ( g / L )$$

$${C}_{3} = Desired fat concentration ( g / L )$$

Thus, while the invention has been described herein with relation to certain embodiments and applications, those with skill in this art will recognize changes, modifications, alterations and the like which still come within the spirit of the inventive concept, and such are intended to be included within the scope of the invention as expressed in the following claims.

1. A method for heat treatment of human breastmilk, comprising keeping breastmilk at an elevated temperature in the range of 57-61° C. for a time span in the range of 5-60 minutes.

2. A method according to claim 1, wherein for elevated temperatures above 60° C. the breastmilk is kept at this temperature for not more than 30 minutes.

3. A method according to claim 1, wherein the human breastmilk is kept at a temperature in the range of 59-61° C.

4. A method according to claim 1, wherein the human breastmilk is kept at a temperature in the range of 59-60° C.

5. A method according to claim 1, wherein the breastmilk is kept at the elevated temperature for a time span of at least 15 minutes and not more than 30 minutes.

6. A method according to claim 1 wherein the elevated temperature is held constant during the time span.

7. A method according to claim 1, wherein the elevated temperature is applied in intervals of the elevated temperature and intermediate intervals of a temperature at least 20° C. below the value of the elevated temperature.

8. A method according to claim 7 wherein the time span is given by the accumulated time of the intervals of elevated temperature.

9. A method according to claim 7 wherein the temperature in the intermediate interval is below room temperature.

10. A method according to claim 9 wherein the temperature in the intermediate interval is below 10° C.

11. A method according to claim 9 wherein the temperature in the intermediate interval is below 4-6° C.

12. A method according to claim 1, wherein the time to rise from approximately room temperature to the elevated temperature is in the range of 10-120 seconds.

13. A method according to claim 12, wherein the time to decay from the elevated temperature to approximately room temperature or a temperature below room temperature is in the range of 10-120 seconds.

14. Use of the method according to claim 1 for the production of microbiologically and/or virally safe breastmilk while keeping the level of at least one of the following constituents at a value substantially equal to the value of untreated human breastmilk: lactoferrin; lysozyme; IgA; sIgA; IgM; IgG; lipoprotein lipase; bile salt activated lipase; Vitamin A; Vitamin B12; oligosaccharides; free fatty acids; monoglycerides; and folic acid.

15. A method of treating human breastmilk, comprising:
heating a quantity of human breastmilk to a temperature of about 57° C. in less than about 5 minutes; and
maintaining the heated breastmilk within a temperature range having a minimum temperature of about 56° C. to a maximum temperature of less than about 60° C. for a period of about 30 minutes.

16. The method of claim 15, further including cooling the heated breastmilk to a desired temperature in less than about 5 minutes.

17. The method of claim 15, wherein the human breastmilk is heated to a temperature of about 57° C. in about one minute.

18. The method of claim 15, wherein the human breastmilk is heated to a temperature of about 57° C. in less than about one minute.

19. The method of claim 15, wherein the heated human breastmilk is maintained within a temperature range of about 56° C. to about 58° C. for a period of about 30 minutes.

20. An improved method for pasteurization of mother's milk that maximizes the retention of protein bioactivity while still removing effective amounts of dangerous bacteria and viruses, comprising the steps of:
rapidly raising the temperature of the milk to an optimal temperature, wherein said optimal temperature is in a range of between about 57° C. and about 60° C.;
holding the milk at or about said optimal temperature for a period sufficient to effect pasteurization; and then
allowing the milk to cool down after said holding period.

21. The method of claim 20, wherein said optimal temperature is about 57° C.

22. The method of claim 20, wherein said holding period is about 30 minutes.

23. The method of claim 20, wherein said holding period is about 45 minutes.

24. An improved method for adjusting the milk fat content of mother's milk comprising the steps of:
separating the milk contents into at least milk fat and skim milk layers, with said separation operation being insufficient to prevent re-suspension of said milk fat and skim milk layers thereafter;
removing milk from said skim milk layer to thereby increase the milk fat concentration; and
re-suspending said milk fat layer with said skim milk layer.

25. The method of claim 24, wherein said separating step is accomplished through centrifugation.

26. The method of claim 24, wherein said re-suspension step is accomplished through manual shaking of said milk fat and skim milk in a container.
